(19) United States
(12) Patent Application Publication
(10) Pub. No.: US 2010/0082494 A1
(43) Pub. Date: Apr. 1, 2010

(54) METHOD AND SYSTEM FOR CASH TRANSFER

(75) Inventor: Ashutosh SAXENA, Ahmedabad (IN)

Correspondence Address: CANTOR COLBURN, LLP, 20 Church Street, 22nd Floor, Hartford, CT, 06103, US

(73) Assignee: INFOSYS TECHNOLOGIES LIMITED, Bangalore (IN)

(21) Appl. No.: 12/567,878

(22) Filed: Sep. 28, 2009

(30) Foreign Application Priority Data
Sep. 29, 2008 (IN) 2379/CHE/2008

(51) Int. Cl. G06Q 40/00; G07F 19/00; H04L 9/00

(52) U.S. Cl. 705/75; 235/379

(57) ABSTRACT

A method and system for transferring cash electronically from a sender to a receiver through cash machines and a mobile device is disclosed. On initiation of a transaction by a sender on a cash machine, a coupon containing details of the transaction is generated by the system. The coupon is sent to the mobile device of the receiver. The receiver uses the coupon for withdrawing cash from a designated cash machine. On withdrawal of the cash by the receiver, the sender receives a confirmation from a bank.

### BACKGROUND

The present invention relates generally to electronic cash transfer and specifically, to a method and system for transferring cash electronically from a sender to a receiver through cash machines and a mobile device.

Cash machines, also known as automated teller machines (ATMs), have become widely available over the past few years due to their popularity. Nowadays, ATMs are placed near banks, airports, universities, shopping malls and the like for easy accessibility. A person can access his/her bank account through an ATM using a debit card or a credit card and withdraw cash anytime. Though ATMs have traditionally been used as cash withdrawal machines, they also provide facilities for depositing cash, checking account balance, transferring money from one account to another, and so forth. Further, nowadays, it is also possible to withdraw cash from an ATM owned by a bank using a debit card issued by a different bank.

One of the important facilities provided by the ATMs is transfer of money between two accounts. To transfer money from one account to another through ATMs, typically, a sender has to input a receiver's account number and the transfer amount after which the money is transferred to the receiver's account. Thus, a prerequisite for such a method is that the receiver should have an account with a bank. However, there arise situations when money needs to be transferred to a receiver not having an account with any bank.

Accordingly, there is a need for a method and system for transferring money through ATMs even when the receiver does not have an account in any bank. Further, the method and system should be convenient for both the sender and the receiver.

### SUMMARY OF THE INVENTION

According to one embodiment of the present invention, a method for transferring cash electronically from a sender to a receiver is disclosed. A sender initiates a transaction through a sender cash machine and inputs a secret code. The sender cash machine generates a coupon having a critical component and a non-critical component, along with a secret key. Further, the sender cash machine encrypts the critical component and sends the encrypted critical component and the non-critical component to the receiver cash machine. The sender cash machine also sends the non-critical component to the receiver, while the sender sends the secret code to the receiver. The receiver inputs the non-critical component and the secret code through the receiver cash machine. The receiver cash machine validates the non-critical component inputted by the receiver and transfers the cash to the receiver based on the validation.

According to one embodiment of the present invention, a system for transferring cash electronically from a sender to a receiver is disclosed. The system includes a coupon generation module that, for a transaction initiated by a sender, generates a coupon having a critical component and a non-critical component along with a secret key. The system further includes a processor for encrypting and decrypting the critical component of the coupon. The system also includes a communication module for sending and receiving the encrypted critical component along with the non-critical component. The system further includes a validation module for validating the non-critical component inputted by the receiver. The system also includes a transfer module for transferring the cash to the receiver based on the validation.

### DRAWINGS

These and other features, aspects, and advantages of the present invention will be better understood when the following detailed description is read with reference to the accompanying drawings in which like characters represent like parts throughout the drawings, wherein:

FIG. 1 illustrates an environment in which the present invention may be practiced, in accordance with an embodiment of the present invention.

FIG. 2 is a block diagram of a system for transferring funds electronically from a sender to a receiver, in accordance with an embodiment of the present invention.

FIG. 3 is a flowchart describing a method for transferring cash electronically from a sender to a receiver, in accordance with an embodiment of the present invention.

### DETAILED DESCRIPTION

The following description is the full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to get an advantage without the corresponding use of other features described in the following paragraphs. As such, the present description should be considered as merely illustrative of the principles of the present technique and not in limitation thereof, since the present technique is defined solely by the claims.

The present invention relates to a system for transferring cash electronically from a sender to a receiver and a method thereof. The system includes a coupon generation module that generates a coupon having a critical component and a non-critical component, along with a secret key. The system further includes a processor for encrypting and decrypting the critical component of the coupon. The system also includes a communication module for sending the encrypted critical component and the non-critical component, as well as receiving them. The system further includes a validation module for validating the non-critical component inputted by the receiver. The system also includes a transfer module for transferring the cash to the receiver based on the validation.

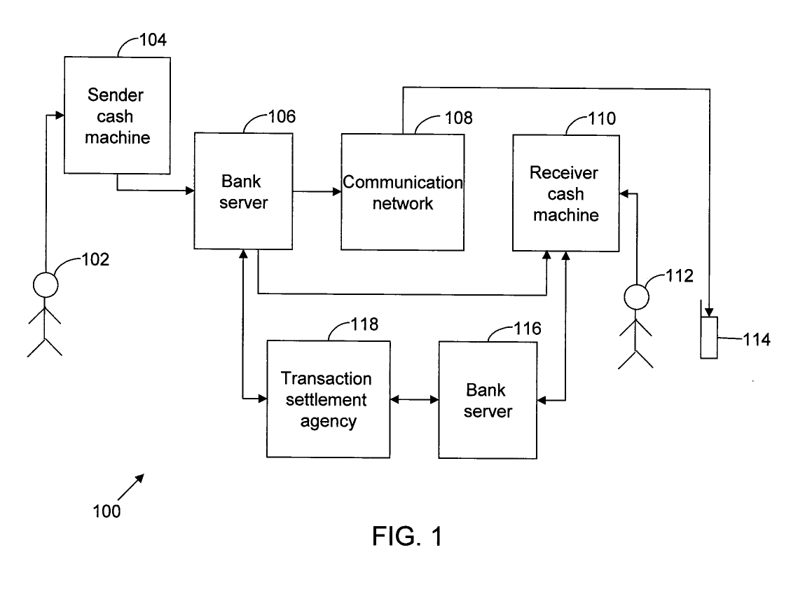

FIG. 1 illustrates an environment 100 in which the present invention may be practiced, in accordance with an embodiment of the present invention. Environment 100 includes a sender 102, a sender cash machine 104, a bank server 106, a communication network 108, a receiver cash machine 110, a receiver 112, a mobile device 114, a bank server 116, and a transaction settlement agency 118.

Sender 102 accesses sender cash machine 104 and initiates a transaction. Along with necessary details, sender 102 inputs a secret code through sender cash machine 104 and communicates the secret code to receiver 112. Sender cash machine 104 generates a coupon having a critical component and a non-critical component. Further, sender cash machine 104 generates a secret key using the secret code inputted by sender 102 and encrypts the critical component of the coupon to generate an encrypted critical component. Sender cash machine 104 sends the encrypted critical component along with the non-critical component to bank server 106. After authenticating the encrypted critical component and the non-critical component, bank server 106 sends the encrypted critical component and the non-critical component to receiver cash machine 110. Further, bank server 106 sends the non-critical component to receiver 112 through communication network 108. Receiver 112 accesses receiver cash machine 110 and inputs the non-critical component of the coupon along with the secret code. Receiver cash machine 110 validates the non-critical component using the encrypted critical component and transfers the cash to receiver 112.

In accordance with various embodiments of the present invention, sender 102 uses a swipe card such as an automated teller machine (ATM) card, a debit card, a credit card, or any other alternate mechanism to initiate a transaction on sender cash machine 104. Sender 102 inputs details such as name of the receiver, contact number of the receiver, transfer amount, location of the receiver cash machine, time period for withdrawal, and other details necessary to carry out the transaction through sender cash machine 104. Further, sender 102 inputs a secret code through sender cash machine 104 and communicates the secret code to receiver 112. Sender 102 communicates the secret code to receiver 112 via any of a call, a short message service (SMS), e-mail, or by any other secure channel. The secret code may include numbers, letters, or their combination such as alphanumeric data.

Sender cash machine 104 includes an input mechanism such as a keypad, a touch screen, or their combination through which sender 102 initiates the transaction. Sender cash machine 104 generates a coupon after sender 102 has inputted all the details necessary for the transaction. The coupon includes a critical component and a non-critical component. The critical component includes details such as a transaction identifier, sender cash machine identity, receiver cash machine identity, transfer amount, and the like. Thus, the critical component may include information generated by sender cash machine 104 along with one or more details inputted by sender 102. The non-critical component includes details such as name of the receiver, contact number of the receiver, location of the receiver cash machine, time period for withdrawal, and so forth. In accordance with an embodiment of the present invention, the critical component of the coupon includes one or more details present in the non-critical component, such as, for example, the transaction identifier. It will be apparent to a person skilled in the art that any other important information relevant to the transaction may also be included in the critical or the non-critical component of the coupon.

In accordance with an embodiment of the present invention, sender cash machine 104 generates a secret key using the secret code inputted by sender 102. The secret key may include numbers, letters, or their combination such as alphanumeric data. Further, sender cash machine 104 encrypts the critical component of the coupon using the secret key to generate an encrypted critical component. Sender cash machine 104 may use any one of various symmetric or asymmetric cryptography algorithms or a combination of these algorithms to generate the secret key and encrypt the critical component. Sender cash machine 104 sends the encrypted critical component and the non-critical component to bank server 106 for authentication.

Bank server 106 receives the encrypted critical component and the non-critical component for authentication. Bank server 106 verifies authenticity and integrity of the coupon using techniques known in the art. In accordance with an embodiment of the present invention, bank server 106 also authorizes the coupon. After authentication and/or authorization, bank server 106 sends both the encrypted critical component and the non-critical component to receiver cash machine 110. Further, bank server 106 also sends the non-critical component to receiver 112 through communication network 108. In accordance with an embodiment of the present invention, bank server 106 generates a message, wraps the non-critical component of the coupon in the message and sends the message to receiver 112 on a mobile device 114 through communication network 108.

In accordance with an embodiment of the present invention, receiver 112 receives the non-critical component in the form of a message on mobile device 114. Receiver 112 inputs the non-critical component along with the secret code through receiver cash machine 110. Specifically, receiver 112 inputs one or more details present in the non-critical component, such as the transaction identifier, that is common to both the critical component and the non-critical component.

Receiver cash machine 110 receives the encrypted critical component and the non-critical component of the coupon from bank server 106. Further, receiver cash machine 110 validates the non-critical component inputted by receiver 112 along with the secret code through receiver cash machine 110. In accordance with an embodiment of the present invention, when receiver 112 inputs the secret code, receiver cash machine 110 generates a secret key using the secret code and the same algorithm as in sender cash machine 104. It should be noted that when the secret code inputted by receiver 112 is identical to the secret code inputted by sender 102, a secret key identical to the one generated in sender cash machine 104 is generated in receiver cash machine 110. Receiver cash machine 110 then decrypts the encrypted critical component using the secret key.

In accordance with an embodiment of the present invention, the non-critical component of the coupon includes one or more details included in the critical component of the coupon. For example, both the critical and the non-critical components include the transaction identifier. The transaction identifier is a unique number containing alphanumeric data that is generated by sender cash machine 104 every time a transaction is initiated. Thus, in this example, receiver 112 inputs the transaction identifier through receiver cash machine 110. Receiver cash machine 110 compares the transaction identifier inputted by receiver 112 with the transaction identifier obtained by decrypting the encrypted critical component using the secret key. Based on the comparison, receiver cash machine 110 transfers the cash to receiver 112. Thus, receiver cash machine 110 transfers the cash when the two transaction identifiers match, otherwise, receiver cash machine 110 notifies receiver 112 regarding the mismatch using an error message.

In accordance with an embodiment of the present invention, after receiver 112 withdraws the cash from receiver cash machine 110, bank server 106 and bank server 116 communicate with transaction settlement agency 118 for settlement of the transaction. It may be apparent to a person skilled in the art that when bank server 106 and bank server 116 belong to the same bank, the two bank servers may communicate directly without any need for transaction settlement agency 118.

In accordance with an embodiment of the present invention, bank server 106 sends a confirmation to sender 102 after receiver 112 withdraws the cash from receiver cash machine 110. Bank server 106 may send the confirmation to sender 102 via any of short message service (SMS), multimedia messaging service (MMS), mobile instant message, e-mail, and so forth.

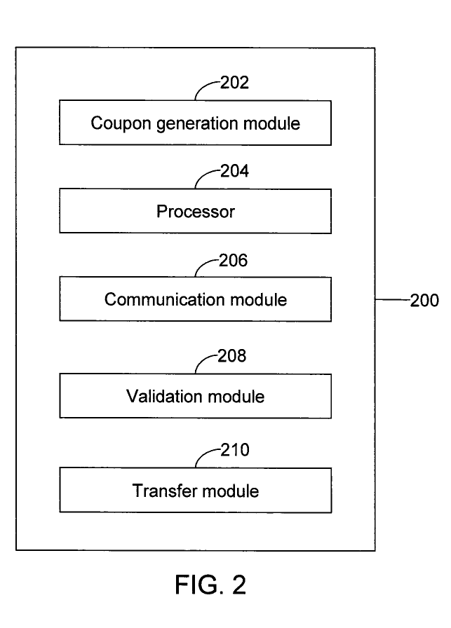

FIG. 2 is a block diagram of a system 200 for transferring funds electronically from a sender to a receiver, in accordance with an embodiment of the present invention. System 200 includes a coupon generation module 202, a processor 204, a communication module 206, a validation module 208 and a transfer module 210. It should be noted that these modules are present in a sender cash machine as well as a receiver cash machine in addition to other elements integral to the working of the sender cash machine and the receiver cash machine.

Coupon generation module 202 generates a coupon for a transaction initiated by a sender through a sender cash machine, such as sender cash machine 104. In accordance with various embodiments of the present invention, the coupon includes a critical component and a non-critical component. The critical component includes details such as a transaction identifier, sender cash machine identity, receiver cash machine identity, transfer amount, and the like. The non-critical component includes details such as name of the receiver, contact number of the receiver, location of the receiver cash machine, time period for withdrawal, and so forth. Further, when a sender inputs a secret code through the sender cash machine, coupon generation module 202 generates a secret key using any one of various symmetric and asymmetric cryptography algorithms or their combination. In accordance with an embodiment of the present invention, the secret key may include numbers, letters or alphanumeric data. Similarly, when a receiver inputs the secret code through the receiver cash machine, such as receiver cash machine 110, coupon generation module 202 generates a secret key using the same algorithm.

Processor 204 encrypts the critical component generated by coupon generation module 202 using any one of the various symmetric and asymmetric algorithms or their combination to generate an encrypted critical component. Further, when the receiver inputs the secret code through the receiver cash machine, processor 204 decrypts the encrypted critical component using the secret key generated by coupon generation module 202 to generate a decrypted critical component.

Communication module 206 sends the encrypted critical component and the non-critical component to a bank server, such as bank server 106, for authentication and/or authorization. Similarly, on the receiving end, communication module 206 receives the encrypted critical component that has been authenticated and/or authorized by the bank server.

Validation module 208 validates the non-critical component inputted by the receiver through the receiver cash machine. In particular, validation module 208 validates the non-critical component using the secret code inputted by the receiver. When the receiver inputs one or more details of the non-critical component, such as the transaction identifier, along with the secret code, validation module 208 compares the transaction identifier with the transaction identifier contained in the decrypted critical component and notifies transfer module 210 about the validation results thereby obtained.

Transfer module 210 transfers the cash to the receiver based on the validation results provided by validation module 208. Thus, for example, if the transaction identifier inputted by the receiver matches the transaction identifier obtained by decrypting the encrypted critical component, transfer module 210 transfers the cash to the receiver. However, if they do not match, transfer module 210 notifies the receiver by generating an error message.

It will be apparent to a person skilled in the art that instead of the transaction identifier, any predefined suitable combination of one or more details contained in the non-critical component may also be inputted by the receiver and used for validation.

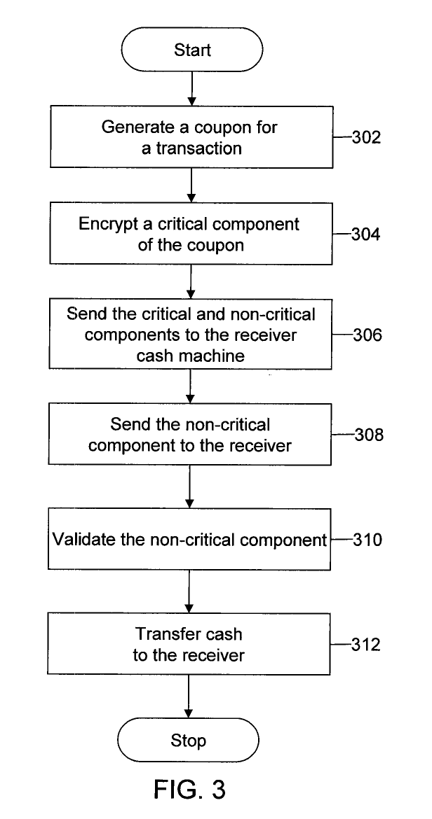

FIG. 3 is a flowchart describing a method for transferring cash electronically from a sender to a receiver, in accordance with an embodiment of the present invention. At step 302, a coupon is generated for a transaction initiated by the sender through a sender cash machine, such as sender cash machine 104. The sender inputs details such as name of the receiver, contact number of the receiver, transfer amount, location of a receiver cash machine, and so forth along with a secret code. The coupon includes a critical component and a non-critical component. Further, a secret key is generated using the secret code inputted by the sender through the sender cash machine. At step 304, the critical component of the coupon is encrypted using the secret key generated by the sender cash machine to generate an encrypted critical component. At step 306, the encrypted critical component and the non-critical component of the coupon are sent to the receiver cash machine, such as receiver cash machine 110. At step 308, the non-critical component of the coupon is sent to the receiver through a communication network. The coupon may be sent in the form of an SMS, an MMS, mobile instant message, and so forth. At step 310, the non-critical component of the coupon inputted by the receiver is validated. In particular, the encrypted critical component of the coupon is decrypted by the receiver cash machine using the secret key and compared with the non-critical component of the coupon inputted by the receiver. At step 312, the cash is transferred to the receiver based on the validation results. Further, a message is sent to the sender through the communication network regarding the withdrawal of the cash by the receiver.

Suitable modifications may be made in the method and system explained above depending on various scenarios. For example, it is possible for a sender to withdraw cash from a receiver cash machine. Thus, in this scenario, the sender and the receiver are the same. After inputting the details necessary for the transaction, such as contact number, location of the receiver cash machine, and so forth through the sender cash machine, the sender receives the non-critical component of the coupon on his mobile device. The sender then accesses the receiver cash machine and withdraws the cash. This may be particularly useful when the sender has to travel outside his own city and does not want to carry cash and the ATM/debit/credit card while travelling. Further, the sender cash machine and the receiver cash machine may also be the same. Thus, a sender may initiate the transaction from the sender cash machine and a receiver may withdraw the cash from the same cash machine at a later point of time. In another scenario, the sender may himself withdraw the cash from the same cash machine on which he initiated the transaction.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

what is claimed is:

1. A method for transferring cash electronically from a sender to a receiver, the sender having access to a sender cash machine, the receiver having access to a receiver cash machine, each of the sender cash machine and the receiver cash machine having an input mechanism, the sender initiating a transaction on the sender cash machine through the input mechanism, the method comprising:
generating a coupon for the transaction, the coupon comprising a critical component and a non-critical component;
encrypting the critical component of the coupon using a secret key to generate an encrypted critical component;
sending the non-critical component of the coupon to the receiver, and the encrypted critical component and the non-critical component of the coupon to the receiver cash machine;
validating at least the non-critical component of the coupon inputted by the receiver through the receiver cash machine; and
transferring the cash to the receiver based on the validation.

2. The method as recited in claim 1, wherein the step of validating is preceded by a step of decrypting the encrypted critical component of the coupon using the secret key.

3. The method as recited in claim 1, wherein the secret key is generated using a secret code.

4. sender. The method as recited in claim 3, wherein the secret code is inputted by the

5. The method as recited in claim 3, further comprising sending the secret code to the receiver.

6. The method as recited in claim 1, wherein the critical component comprises at least one of a transaction identifier, sender cash machine identity, receiver cash machine identity, transfer amount, or combinations thereof.

7. The method as recited in claim 1, wherein the non-critical component comprises at least one of a transaction identifier, name of the receiver, contact number of the receiver, name of the sender, location of the receiver cash machine, time period for withdrawal, or combinations thereof.

8. The method as recited in claim 1, wherein the input mechanism is one of a keypad, a touch screen, or a combination thereof.

9. A system for transferring cash electronically from a sender to a receiver, the sender having access to a sender cash machine, the receiver having access to a receiver cash machine, each of the sender cash machine and the receiver cash machine having an input mechanism, wherein the sender initiates a transaction on the sender cash machine through the input mechanism, the system comprising:
a coupon generation module for:
generating a coupon for the transaction, the coupon comprising a critical component and a non-critical component; and
generating a secret key;
a processor for:
encrypting the critical component of the coupon using the secret key to generate an encrypted critical component; and
decrypting the encrypted critical component of the coupon using the secret key;
a communication module for: sending the non-critical component of the coupon to the receiver, and the encrypted critical component and the non-critical component of the coupon to the receiver cash machine; and
receiving the encrypted critical component of the coupon;
a validation module for validating at least the non-critical component of the coupon inputted by the receiver through the receiver cash machine; and
a transfer module for transferring the cash to the receiver.

10. The system as recited in claim 9, wherein the coupon generation module generates the secret key using a secret code.

11. The system as recited in claim 9, wherein the critical component comprises at least one of a transaction identifier, sender cash machine identity, receiver cash machine identity, transfer amount, or combinations thereof.

12. The system as recited in claim 9, wherein the non-critical component of the coupon comprises at least one of a transaction identifier, name of the receiver, mobile number of the receiver, name of the sender, location of the receiver cash machine, time period for withdrawal, or combinations thereof.

13. The system as recited in claim 9, wherein the input mechanism is one of a keypad, a touch screen, or a combination thereof.

14. A computer storage device tangibly embodying a plurality of instructions adapted for transferring cash electronically from a sender to a receiver, the sender having access to a sender cash machine, the receiver having access to a receiver cash machine, each of the sender cash machine and the receiver cash machine having an input mechanism, wherein the sender initiates a transaction on the sender cash machine through the input mechanism, comprising:
a computer readable medium storing:
a coupon generation module for: generating a coupon for the transaction, the coupon comprising a critical component and a non-critical component; and
generating a secret key;
a processor for:
encrypting the critical component of the coupon using the secret key to generate an encrypted critical component; and
decrypting the encrypted critical component of the coupon using the secret key;
a communication module for:
sending the non-critical component of the coupon to the receiver, and the encrypted critical component and the non-critical component of the coupon to the receiver cash machine; and
receiving the encrypted critical component of the coupon;
a validation module for validating at least the non-critical component of the coupon inputted by the receiver through the receiver cash machine; and
a transfer module for transferring the cash to the receiver.

15. The computer storage device as recited in claim 14, wherein the coupon generation module generates the secret key using a secret code.
